(19) United States
(12) Patent Application Publication
(10) Pub. No.: US 2025/0174696 A1
(43) Pub. Date: May 29, 2025

(54) HIGH-SPEED STACKING DEVICE, STACKING PRODUCTION LINE AND STACKING PROCESS

(71) Applicant: Dongguan Chaohong Automation Equipment Co., Ltd., Dongguan City (CN)

(72) Inventors: Huaming TAN, Dongguan City (CN); Jun LI, Dongguan City (CN); Gang PU, Dongguan City (CN)

(21) Appl. No.: 18/420,531

(22) Filed: Jan. 23, 2024

(30) Foreign Application Priority Data
Nov. 27, 2023 (CN) 2023115903842

(51) Int. Cl. H01M 10/04; B65H 29/22

(52) U.S. Cl. CPC H01M 10/0404; B65H 29/22; H01M 10/0468

(57) ABSTRACT

Provided are a stacking device, a stacking production line and a stacking process, wherein the stacking device comprises a feeding assembly, a conveying assembly, a positioning assembly and a stacking station; the conveying assembly comprises a turntable and a plurality of manipulators arranged on the turntable; the turntable is used for controlling the manipulators to switch among the feeding assembly, the positioning assembly and the stacking station; the stacking production line comprises the high-speed stacking device; and the stacking process is achieved by the high-speed stacking device or the stacking production line, including electrode sheet feeding, electrode sheet positioning, electrode sheet feeding for the second time, stacking, stacking calibration, and unloading. It has the advantages of low device cost and small occupied space, with a reduced personnel cost, and can also realize the uniformity and consistency of stacking without the monitoring by operators.

### CROSS-REFERENCE TO RELATED APPLICATIONS

This application claims priority under 35 U.S.C. § 119 (a) to Chinese Patent Application No. 2023115903842, filed on Nov. 27, 2023, which is hereby incorporated by reference herein in its entirety.

### TECHNICAL FIELD

The disclosure relates to the technical field of lithium battery production, in particular to a high-speed stacking device, a stacking production line and a stacking process.

### BACKGROUND ART

Existing stacking machines usually adopt a straight-line production layout, with manipulators placed on both sides of the stacking station. The positive and negative material sheets are stacked according to predetermined specifications and sequence through the linear reciprocating motion of the manipulators. Alternatively, swinging material placement platforms in a three-dimensional space on both sides of the stacking station for stacking. However, both of these methods have different defects:

1. The disadvantage of stacking with the manipulators lies in its limited application range, typically being only suitable for the stacking of electrode material sheets with a small size. For electrode material sheets with a large size or a special shape, it may not meet the requirements of stacking, and this stacking method requires a high precision for the manipulators and a high requirement for electrode material sheets. If the electrode material sheets are deformed, it may lead to uneven stacking and affect the performance and consistency of the battery;

2. The disadvantage of stacking by swinging the material placement platforms lies in a complex device structure and control system, which increases the manufacturing and maintenance cost of the device. In a stacking process, it is necessary to accurately control the motion trajectory and speed of a swing arm for the material placement platform to ensure a uniform stacking of electrode material sheets. Such method requires conducting special training for operators to continuously monitor and adjust during the operation so as to avoid uneven or inconsistent stacking.

### SUMMARY

In order to overcome the shortcomings of the prior art, the disclosure provides a high-speed stacking device, a stacking production line and a stacking process, wherein the high-speed stacking device is provided with a turntable to control a manipulator to switch among a feeding assembly, a positioning assembly and a stacking station. The stacking production line comprises the high-speed stacking device, and the stacking process is carried out by the high-speed stacking device or the stacking production line. The present disclosure achieves the advantage that it has low device cost and small occupied space, with a reduced personnel cost, and can also realize the uniformity and consistency of stacking without the monitoring by operators.

The technical scheme adopted by the disclosure to solve the technical problems is as follows:

A high-speed stacking device comprising a feeding assembly, a conveying assembly, a positioning assembly and a stacking station, wherein the feeding assembly comprises a linear feeding module with two actuators, one of the actuators of the linear feeding module is used for conveying a positive electrode sheet, and the other actuator of the linear feeding module is used for conveying a negative electrode sheet; the conveying assembly comprises a turntable and a plurality of manipulators arranged on the turntable, wherein the manipulators are used for picking up and conveying the electrode sheet, and the turntable is used for controlling the manipulator to switch among the feeding assembly, the positioning assembly and the stacking station; the positioning assembly is used for positioning and rectifying deviation of the electrode sheet; the stacking station is used for stacking; wherein the positioning assembly comprises a positive electrode sheet positioning assembly and a negative electrode sheet positioning assembly symmetrically arranged around the turntable; and wherein the feeding assembly, the positive electrode sheet positioning assembly, the stacking station and the negative electrode sheet positioning assembly are arranged in a circular distribution centered around the conveying assembly.

According to one or more embodiments, the turntable is provided with a first lifting device for controlling the lifting of the manipulator, and the manipulator lifting device is a motor screw assembly, and the manipulator is connected with a screw in the motor screw assembly, and the manipulator is provided with a plurality of vacuum adsorption holes for adsorbing the electrode sheet.

According to one or more embodiments, the positioning assembly comprises a positioning table, a first camera assembly arranged above the positioning table, and an adjusting assembly arranged below the positioning table; wherein the first camera assembly takes pictures of the electrode sheet on the positioning table when the manipulator places an electrode sheet on the positioning table, and the position of the positioning table is calibrated by the adjusting assembly.

According to one or more embodiments, the stacking station comprises a stacking base plate, and two groups of pressing claw assembly are symmetrically arranged around the stacking base plate, and the pressing claw assembly comprise a second lifting device, a first transverse moving device arranged at an output end of the second lifting device and a pressing claw arranged at an output end of the first transverse moving device, and the two groups of pressing claw assembly work alternately for pressing electrode sheet on the stacking base plate.

According to one or more embodiments, two groups of second camera assembly are arranged above the stacking station, which are symmetrical with the stacking base plate as the center, and the second camera assembly cooperates with the pressing claw assembly for detecting the spacing between the positive electrode sheet and negative electrode sheet on the stacking base plate.

According to one or more embodiments, the high-speed stacking device also comprises a swing roller assembly for guiding the direction of a separator for stacking, wherein the swing roller assembly comprises a swing roller bottom plate, a swing roller frame, a swing roller arranged on the swing roller frame and a swing roller driving device for controlling the position of the swing roller, wherein the stacking station is arranged on the swing roller bottom plate, the swing roller frame is rotatably arranged at two ends of the stacking station, and the swing roller driving device has two output ends, and the two output ends of the swing roller driving devices are each connected to a connecting rod through an eccentric wheel, wherein one end of the connecting rod, away from the eccentric wheel, is connected to the swing roller frame.

According to one or more embodiments, both ends of the linear feeding module are provided with a slicing and picking device, which comprises a slicing and picking mechanism, a rotating mechanism for controlling the rotation of the slicing and picking mechanism and a third lifting mechanism for controlling the lifting of the slicing and picking mechanism, wherein the slicing and picking mechanism comprises a picking assembly and a slicing assembly, wherein the slicing assembly comprises a supporting plate and a folding assembly arranged on the supporting plate, and the picking assembly arranged on two sides of the supporting plate are movably connected with the folding assembly respectively, and the slicing and picking mechanism further comprises a cam structure for limiting movement of the picking assembly.

According to one or more embodiments, the picking assembly comprises a picking plate and a plurality of vacuum suction cups uniformly distributed on the picking plate; wherein the cam structure comprises a limiting plate with a limiting groove and a moving plate with a protruding structure; the limiting plate is arranged on the supporting plate; the moving plate is fixedly arranged on the picking plate; the protruding structure is limited in the limiting groove; the folding assembly comprises a folding driving device and a folding plate connected to an output end of the folding driving device; the folding plate is provided with a rotating shaft; a fixing plate is arranged on the picking plate, and the fixing plate is connected to the rotating shaft through the swing arm.

The disclosure also provides a stacking production line, which comprises the high-speed stacking device.

The disclosure also provides a stacking process, which adopts the high-speed stacking device or the stacking production line for stacking electrode sheets, and comprises the following steps:
S1, electrode sheet feeding; conveying, by the linear feeding module, a positive/negative electrode sheet to a middle part thereof, controlling, by the turntable, the manipulator to rotate to the upper part of the linear feeding module, and controlling, by the first lifting device, the manipulator to descend and pick up the electrode sheet and then ascend;
S2, electrode sheet positioning; controlling the turntable to rotate to drive the manipulator picking up the electrode sheet to rotate to the positioning assembly and placing the electrode sheet on the positioning table, taking pictures by the first camera assembly to detect the position of the electrode sheet, and adjusting and positioning the positioning table in cooperation with the adjusting assembly;
S3, electrode sheet feeding for second time; picking up the electrode sheet after positioning adjustment by the positioning table by the manipulator;
S4, stacking; guiding, by the swing roller assembly, a separator in a Z-shaped direction, placing, by the manipulator, the electrode sheet on the stacking station, and pressing the electrode sheet on the stacking base plate in cooperation with the pressing claw assembly;
S5, stacking calibration; recording, by the cooperation of the pressing claw assembly and the second camera assembly, the variable distance between the positive electrode sheet and negative electrode sheet to judge whether production requirements are met; and
S6, unloading; unloading a battery cell after a finished stacking.

The disclosure has the beneficial effects that:
a high-speed stacking device, a stacking production line and a stacking process, wherein the high-speed stacking device is provided with a turntable to control a manipulator to switch among a feeding assembly, a positioning assembly and a stacking station. The stacking production line comprises the high-speed stacking device, and the stacking process is carried out by the high-speed stacking device or the stacking production line. The present disclosure achieves the advantage that it has low device cost and small occupied space, with a reduced personnel cost, and can also realize the uniformity and consistency of stacking without the monitoring by operators.

### BRIEF DESCRIPTION OF THE DRAWINGS

The disclosure will be further explained with the attached drawings and embodiments.

FIG. 1 is a schematic view of a stacking device according to one or embodiments of the present disclosure;

FIG. 2 is a schematic view from another angle of the stacking device according to one or embodiments of the present disclosure;

FIG. 3 is a schematic view of a conveying assembly according to one or embodiments of the present disclosure;

FIG. 4 is a schematic view of a linear feeding module according to one or embodiments of the present disclosure;

FIG. 5 is a schematic view of a slicing and picking device according to one or embodiments of the present disclosure;

FIG. 6 is a partial structural schematic view of the slicing and picking device according to one or embodiments of the present disclosure;

FIG. 7 is a partial structural schematic view of the slicing and picking device according to one or embodiments of the present disclosure;

FIG. 8 is a partial structural schematic view of the slicing and picking device according to one or embodiments of the present disclosure;

FIG. 9 is a schematic view of a manipulator according to one or embodiments of the present disclosure;

FIG. 10 is a schematic view of a positioning assembly according to one or embodiments of the present disclosure;

FIG. 11 is a schematic view of a stacking station according to one or embodiments of the present disclosure;

FIG. 12 is a schematic view of the stacking station in FIG. 11 from another angle; and

FIG. 13 is a schematic view of a swing roller assembly according to one or embodiments of the present disclosure.

### DESCRIPTION OF REFERENCE SIGNS

1 is a feeding assembly; 5 is a conveying assembly; 2 is a positive electrode sheet positioning assembly; 3 is a negative electrode sheet positioning assembly; 4 is a stacking station; 10 is a linear feeding module; 11 is an actuator; 110 is a feeding suction cup; 70 is a third lifting mechanism; 71 is a rotating mechanism; 72 is a picking mechanism; 34 is a supporting plate; 33 is a folding assembly; 30 is a picking plate; 31 is a vacuum suction cup; 330 is a folding driving device; 331 is a folding plate; 332 is a rotating shaft; 333 is a fixing plate; 334 is a swing arm; 353 is a limiting groove; 352 is a limiting plate; 350 is a moving plate; 351 is a protruding structure; 54 is a turntable; 503 is a screw motor; 504 is a synchronizing wheel assembly; 505 is a screw; 506 is a pulley; 502 is a connecting plate; 501 is a picking hand; 60 is a first camera assembly; 20 is a positioning table; 22 is a positioning suction cup; 21 is an adjusting assembly; 460 is a stacking base plate; 61 is a second camera assembly; 461 is a first motor; 4610 is a first lifting table; 4620 is a first driving belt; 462 is a first driving device; 4621 is a first connecting block; 4622 is a second connecting block; 4623 is a first pressing claw; 4624 is a second pressing claw; 465 is a fourth lifting device; 40 is a swing roller bottom plate; 44 is a swing roller frame; 45 is a swing roller; 41 is a swing roller driving device; 42 is an eccentric wheel; 43 is a connecting rod; 50 is a first manipulator; 51 is a second manipulator; 52 is a third manipulator; and 53 is a fourth manipulator.

### DETAILED DESCRIPTION

In the following, the concept, specific structure and technical effects of the disclosure will be clearly and completely described with embodiments and drawings, so as to fully explain the purpose, characteristics and effects of the disclosure. Obviously, the described embodiment is only a part of the embodiment of the present disclosure. Based on the embodiment of the present disclosure, other embodiments obtained by those skilled in the art without creative labor are included in the scope of protection of the present disclosure. In addition, all the connecting/connection relationships involved in the disclosure do not mean that the single-finger assembly are directly connected, but that a better connection structure can be formed by adding or reducing connection accessories according to a specific implementation situation. Various technical features in the disclosure can be combined interactively on the premise of not conflicting with each other.

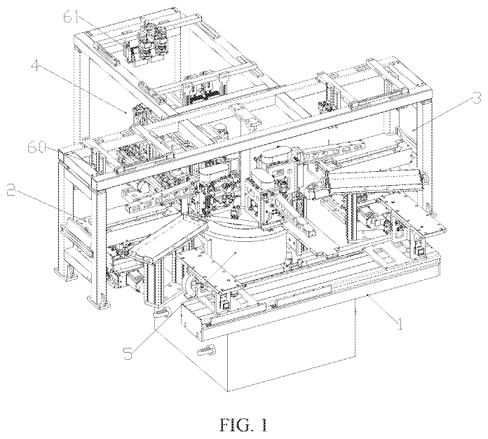

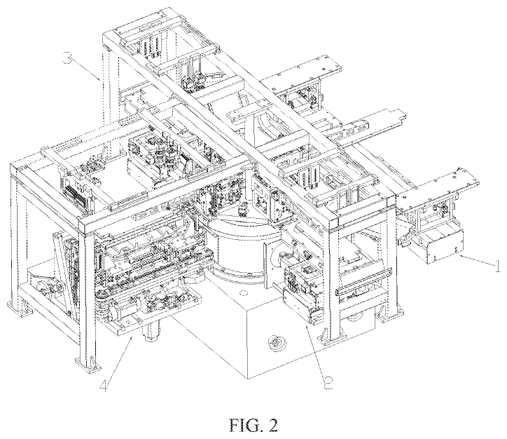

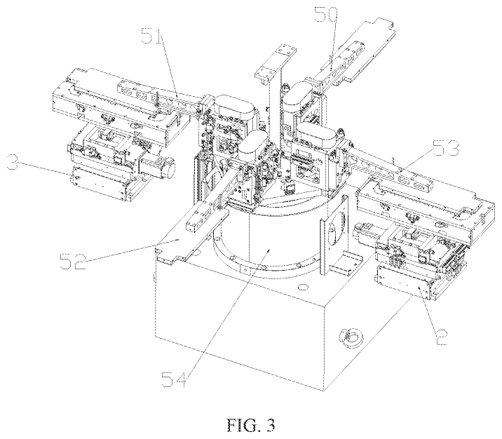

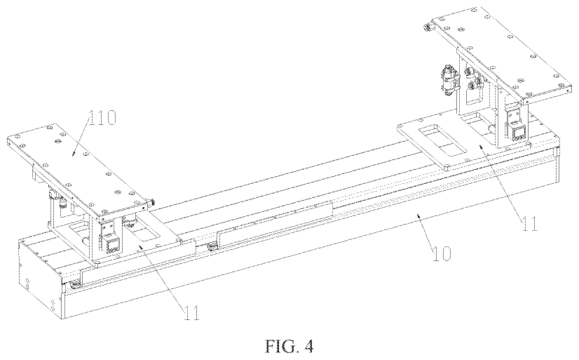

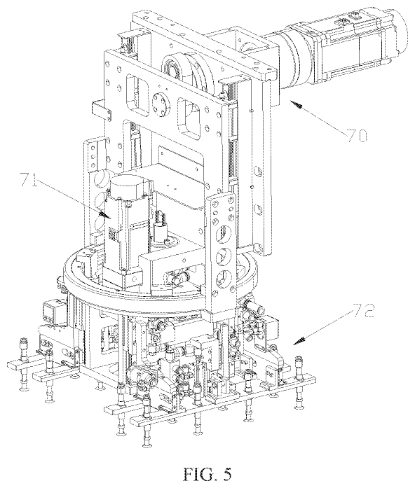

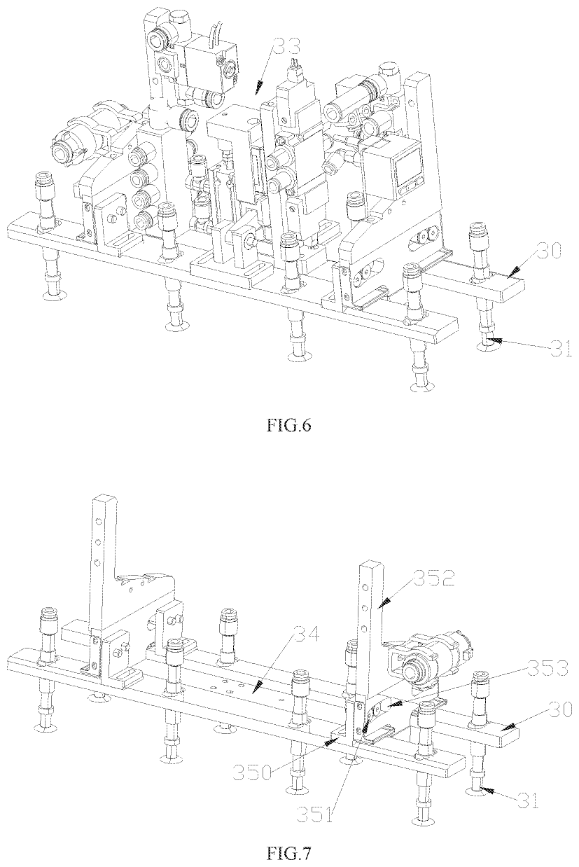

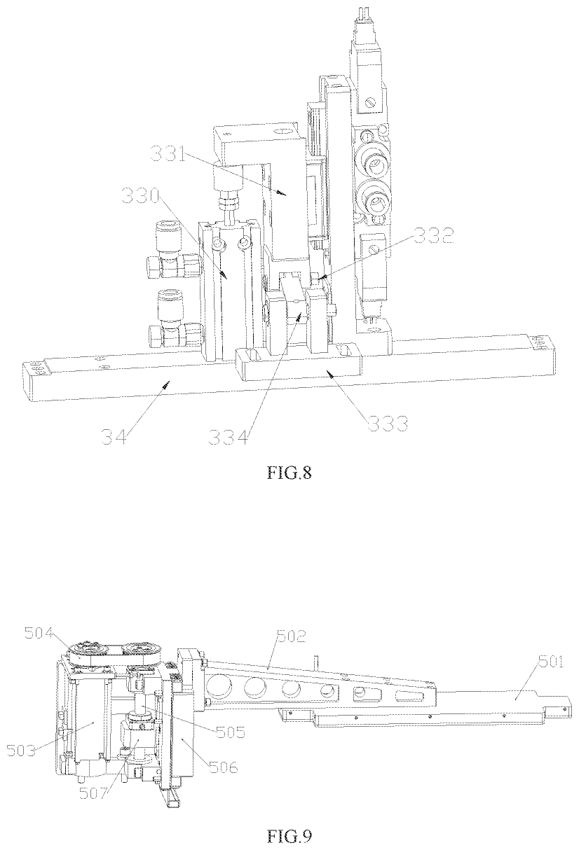

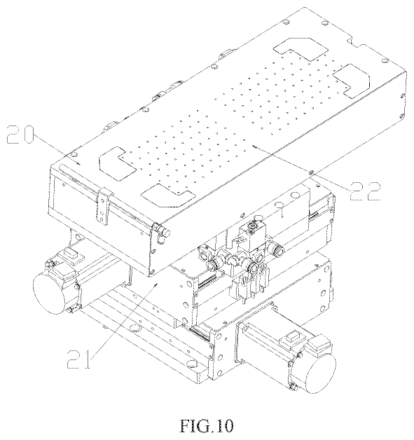

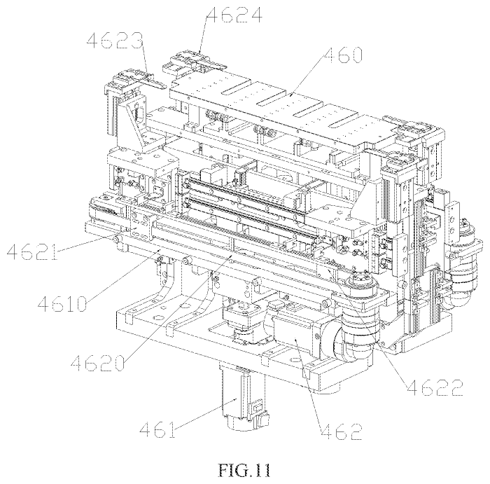

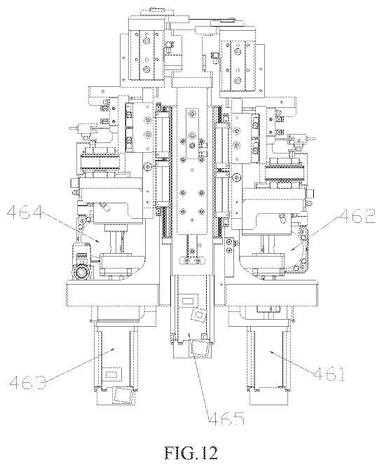

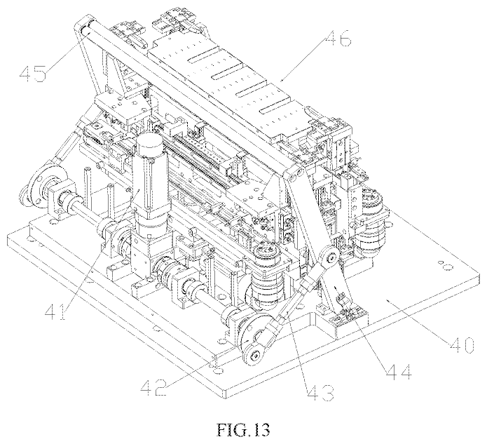

Referring to FIGS. 1 to 13, a high-speed stacking device is provided, which comprises a feeding assembly 1, a conveying assembly 5, a positioning assembly and a stacking station 4. The positioning assembly comprises a positive electrode sheet positioning assembly 2 and a negative electrode sheet positioning assembly 3. The feeding assembly 1, the positive electrode sheet positioning assembly 2, the stacking station 4 and the negative electrode sheet positioning assembly 3 are arranged in a circular distribution centered around the conveying assembly 5.

The feeding assembly 1 comprises a linear feeding module 10 with two actuators 11, one of which is used for conveying a positive electrode sheet, and the other of which is used for conveying a negative electrode sheet. Specifically, the actuator 11 is connected with a feeding fixture, which is provided with a plurality of feeding suction cups 110, which can adsorb the electrode sheet when it is placed on the feeding fixture.

Both ends of the linear feeding module 10 are provided with a slicing and picking device, which include a slicing and picking mechanism 72, a rotating mechanism 71 for controlling the rotation of the slicing and picking mechanism 72, and a third lifting mechanism 70 for controlling the lifting of the slicing and picking mechanism 72. The slicing and picking mechanism 72 includes a picking assembly and a slicing assembly. The slicing assembly includes a supporting plate 34 and a folding assembly 33 arranged on the supporting plate 34. The picking assembly is located on both sides of the supporting plate 34, and the picking assembly on each side is respectively pivotally connected to the folding assembly 33. And The slicing and picking mechanism 72 further includes a cam structure for limiting movement of the picking assembly.

The picking assembly comprises a picking plate 30 and a plurality of vacuum suction cups 31 uniformly distributed on the picking plate 30. The cam structure comprises a limiting plate 352 with a limiting groove 353 and a moving plate 350 with a protruding structure 351, wherein the limiting plate 352 is arranged on the supporting plate 34, and the moving plate 350 is fixedly arranged on the picking plate 30, and the protruding structure 351 is limited in the limiting groove 353. The folding assembly 33 includes a folding driving device 330, and a folding plate 331 connected to an output end of the folding driving device 330. The folding plate 331 is provided with a rotating shaft 332. The picking plate 30 is provided with a fixing plate 333, which is connected to the rotating shaft 332 through a swing arm 334.

When the folding driving device 330 drives the folding plate 331 to move, the folding plate 331 drives the picking plate 30 to move, and then the protruding structure 351 slides along the limiting groove 353, which can guide and limit the movement of the picking plate 30. As a result, both sides of the electrode sheet become arc-shaped during the slicing process, achieving the slicing effect without damaging the edge of the electrode sheet, while improving the slicing time-efficiency.

For easy of illustration, a first end of the linear feeding module 10 is set as a positive electrode sheet feeding end, an actuator 11 for conveying the positive electrode sheet is set as a first actuator 11, the other end of the linear feeding module 10 is set as a negative electrode sheet feeding end, and the other actuator 11 for conveying the negative electrode sheet is set as a second actuator 11. When it is necessary to feed the positive electrode sheet, the sliding and picking device at the positive electrode sheet feeding end picks up the positive electrode sheet and places it on the first actuator 11 on the linear feeding module 10; the first actuator 11 carries the positive electrode sheet to the middle of the linear feeding module 10; and then the positive electrode sheet is taken away by the conveying assembly 5. Next, the feeding action of the negative electrode sheet is carried out at negative electrode sheet feeding end after the positive electrode sheet is taken away. As the feeding action of the negative electrode sheet is the same as that of the positive electrode sheet, the details are not repeated.

The conveying assembly 5 comprises a turntable 54 and a plurality of manipulators arranged on the turntable 54, wherein the manipulators are used for picking up and conveying the electrode sheet, and the turntable 54 is used for controlling the manipulators to switch among the feeding assembly 1, the positioning assembly and the stacking station 4. Specifically, the turntable 54 is provided with a first lifting device, which comprises a screw motor 503, a screw 505 and a pulley 506 arranged on the screw 505. An output end of the screw motor 503 is connected to the screw 505 through a synchronous wheel assembly 504. The manipulator comprises a picking hand 501 and a connecting plate 502 connected to the picking hand 501, and the connecting plate 502 is connected to the pulley 506. The first lifting device is used to control the lifting of the manipulator. The manipulator is equipped with multiple vacuum suction holes on its top for absorbing the electrode sheet.

The positioning assembly is used to position and rectify deviation of the electrode sheet, and the positive electrode sheet or negative electrode sheet can be grasped correspondingly by controlling the rotating direction of the turntable 54. The structure of the positive electrode sheet positioning assembly 2 is the same as that of the negative electrode sheet positioning assembly 3. In this embodiment, the positive electrode sheet positioning assembly 2 is described as an example. The positive electrode sheet positioning assembly 2 includes a positioning table 20, a first camera assembly 60 arranged above the positioning table 20, and an adjusting assembly 21 arranged below the positioning table 20. The positioning table 20 is provided with a plurality of positioning suction cups 22 for adsorbing the electrode sheet to ensure that the positions of the electrode sheet will not shift during positioning. When the manipulator places the electrode sheet on the positioning table 20, the first camera assembly 60 takes pictures of the electrode sheet on the positioning table, and the position of the positioning table 20 is calibrated by the adjusting assembly 21. The first camera assembly 60 includes four cameras, and the positioning table 20 is arranged in a rectangular structure, and the four cameras respectively correspond to the four corners of the positioning table 20. When the electrode sheet is placed on the positioning table 20, the four cameras can photograph four corners of the electrode sheet and compare them with a predetermined position. If the position of the electrode sheet is found to be deviated, the adjusting assembly 21 is controlled to adjust the position of the positioning table 20. In this embodiment, the adjusting assembly 21 includes a XYR positioning platform, which is a mature technology in the industry and will not be described here.

The stacking station 4 includes a stacking base plate 460. In order to cooperate with the manipulator in stacking, the stacking station 4 needs to lower the height of one electrode sheet every time it stacks. Therefore, a fourth lifting device 465 is arranged below the stacking base plate 460, and an output end of the fourth lifting device 465 is connected to the stacking base plate 460 for controlling the vertical height of the stacking base plate 460.

According to one or more embodiments, two groups of pressing claw assembly are symmetrically arranged around the stacking base plate 460, and the pressing claw assembly comprise a second lifting device, a first transverse moving device arranged at an output end of the second lifting device and a pressing claw arranged at an output end of the first transverse moving device. The two groups of pressing claw assembly work alternately to press the electrode sheet on the stacking base plate 460.

In this embodiment, taking a pressing claw assembly at one side of the stacking station 4 as an example. Each group of pressing claw assembly includes two pressing claws located at both ends of the stacking station 4, and the two pressing claws are arranged at the same side of the stacking station 4 for performing pressing action at both ends at the same side of the stacking station 4. The first lifting device comprises a first motor 461, an output end of the first motor 461 is connected with a first lifting table 4610, and the first transverse moving device is arranged on the first lifting table 4610. In this embodiment, the first transverse moving device comprises an annular first transmission belt 4620 and a first driving device 462 for driving the first transmission belt 4620 to move. The first transmission belt 4620 includes two layer belts with parallel and opposite moving directions, one layer belt is connected to the pressing claw at one end of the stacking station 4 through a first connecting block 4621, and the other layer belt is connected to the pressing claw at the other end of the stacking station 4 through a second connecting block 4622. The pressing claws at both ends form a linkage relationship through the first transmission belt 4620, therefore, the approaching and distancing of the two pressing claws can be achieved by controlled the forward and reverse rotation of the first driving device 462. The vertical height of the two pressing claws is controlled through the first lifting device, while the distance between the two grippers is controlled by the first transverse moving device. The combination of the two can drive the pressing claw to press against the stacking station 4.

Two groups of second camera assembly 61 are arranged above the stacking station 4, which are symmetrical with the stacking base plate 460 as the center. The second camera assembly 61 cooperates with the gripper assembly to detect the electrode sheet on the stacking base plate 460. Each group of the second camera assembly 61 includes two cameras, that is two groups of the second camera assembly include four cameras, and the four cameras respectively correspond to the four corners of the stacking base plate 460.

For ease of illustration, a camera located on the left side of the stacking station 4 is set as a first camera, a pressing claw located on the left side of the stacking station 4 is set as a first pressing claw 4623, a camera located on the right side of the stacking station 4 is set as a second camera, and the pressing claw located on the right side of the stacking station 4 is set as a second pressing claw 4624. When the electrode sheet is stacked along the left side of the stacking station 4, the second pressing claw 4624 is controlled to press against the right side of the electrode sheet, and when the electrode sheet is stacked along the right side of the stacking station 4, the first pressing claw 4623 is controlled to press against the left side of the electrode sheet. When the second pressing claw 4624 is pressed against the right side of the electrode sheet, the first camera is controlled to take pictures and record the left side of the electrode sheet, and when the first pressing claw 4623 is pressed against the left side of the electrode sheet, the second camera is controlled to take pictures and record the right side of the electrode sheet. It should be appreciated that the position pressed by the pressing claw is used as a reference point to take pictures of the electrode sheet on the side far away from the pressing claw. After completing one cycle of stacking for the positive electrode sheet and negative electrode sheet, both the first camera and the second camera record a corresponding data about the electrode sheet. The data from both cameras are used to determine the spacing between the positive electrode sheet and negative electrode sheet. This information is then used to infer whether it meets the production requirements.

The high-speed stacking device according to one or more embodiments of the present disclosure further comprises a swing roller assembly for guiding a separator to move to realize stacking, which comprises a swing roller bottom plate 40, a swing roller frame 44, a swing roller 45 arranged on the swing roller frame 44 and a swing roller driving device 41 for controlling the position of the swing roller 45, wherein the stacking station 4 is arranged on the swing roller bottom plate 40, and the swing roller frame 44 is rotatably arranged at both ends of the stacking station 4. The swing roller driving devices 41 have two output ends, and the two output ends of the swing roller driving devices 41 are respectively connected with a connecting rod 43 through an eccentric wheel 42, and an end of the connecting rod 43 far away from the eccentric wheel 42 is connected with the swing roller frame 44. When the swing roller driving device 41 rotates once, it can drive the swing roller frame 44 to swing left and right once, and the swing roller 45 on the swing roller frame 44 drives the separator to swing, so as to cooperate with the stacking station 4 and the manipulator to carry out a Z-shaped stacking.

The disclosure also provides a stacking production line, which comprises the above-mentioned high-speed stacking device.

The disclosure also provides a stacking process, which adopts the above-mentioned high-speed stacking device to stack the electrode sheet or adopts the above-mentioned stacking production line to stack the electrode sheets, including the following steps:
S1, electrode sheet feeding; conveying, by the linear feeding module 10, a positive/negative electrode sheet to a middle part thereof, controlling, by the turntable 54, the manipulator to rotate to the upper part of the linear feeding module 10, and controlling, by the first lifting device, the manipulator to descend and pick up the electrode sheet and then ascend;
S2, electrode sheet positioning; controlling the turntable 54 to rotate to drive the manipulator picking up the electrode sheet to rotate to the positioning assembly and placing the electrode sheet on the positioning table, taking pictures by the first camera assembly 60 to detect the position of the electrode sheet, and adjusting and positioning the positioning table in cooperation with the adjusting assembly 21;
S3, electrode sheet feeding for the second time; picking up the electrode sheet after positioning adjustment by the positioning table by the manipulator;
S4, stacking; guiding, by the swing roller assembly, a separator in a Z-shaped direction, placing, by the manipulator, the electrode sheet on the stacking station 4, and pressing the electrode sheet on the stacking base plate 460 in cooperation with the pressing claw assembly;
S5, stacking calibration; recording, by the cooperation of the pressing claw assembly and the second camera assembly 61, the variable distance between the positive electrode sheet and negative electrode sheet to judge whether production requirements are met; and
S6, unloading; unloading a battery cell after a finished stacking.

In the above step S1, the positive electrode sheet and negative electrode sheet are alternately fed by the linear feeding module 10.

In the above step S4, the Z-shaped direction of the separator is guided by the swing roller assembly, and the manipulator places the electrode sheet on the stacking station 4. When the electrode sheet is stacked along the left side of the stacking station 4, the pressing claw assembly on the right side of the stacking station 4 is controlled to press against the side of the electrode sheet, and when the electrode sheet is stacked along the right side of the stacking station 4, the pressing claw assembly on the left side of the stacking station 4 is controlled to press against the side of the electrode sheet.

In the above step S5, the second camera assembly 61 located on the left side of the stacking station 4 is controlled to take pictures and record the left side of the electrode sheet when the pressing claw assembly located on the right side of the stacking station 4 is pressed against the electrode sheet, and the second camera assembly 61 located on the right side of the stacking station 4 is controlled to take pictures and record the right side of the electrode sheet when the pressing claw assembly located on the left side of the stacking station 4 is pressed against the electrode sheet. And the spacing between the positive electrode sheet and negative electrode sheet can be obtained through the data of the second camera assembly 61 on both sides, so as to calculate whether the production needs are met.

In this embodiment, the turntable 54 is provided with four manipulators, which are cross-symmetrical. For easy of illustration, the four manipulators are sequentially set as a first manipulator 50, a second manipulator 51, a third manipulator 52 and a fourth manipulator 53. During the feeding process, the turntable 54 drives the first manipulator 50 to rotate to the linear feeding module 10 to pick up the positive electrode sheet and transport it to the positive electrode sheet positioning assembly 2. Meanwhile, the second manipulator 51 rotates to the linear feeding module 10 to pick up the negative electrode sheet, and then controls the turntable 54 to rotate reversely to move the second manipulator 51 to the negative electrode sheet positioning assembly 3. While the second manipulator 51 is transporting the negative electrode sheet, the positive electrode sheet positioning assembly 2 has already calibrated and adjusted the position of the positioning table 20. At the same time, the fourth manipulator 53 is located above the positive electrode sheet positioning assembly 2, and the fourth manipulator 53 is controlled to pick up the positive electrode sheet on the positive electrode sheet positioning assembly 2, and then rotated to the stacking station 4 for stacking. At this time, the third manipulator 52 is located above the negative electrode sheet positioning assembly 3, and the third manipulator 52 is controlled to pick up the negative electrode sheet on the negative electrode sheet positioning assembly 3, and then rotated to the stacking station 4 for stacking.

The above merely describes specific embodiments of the present disclosure, which is not intended to limit the scope of protection of the present disclosure. Any modifications, equivalent variations or substitutions, and improvements made within the spirit and principle of the present disclosure by those skilled in the art according to the disclosed technical scope should be included in the protection scope of the present disclosure.

The invention claimed is:

1. A stacking device, comprising a feeding assembly, a conveying assembly, a positioning assembly and a stacking station, wherein the feeding assembly comprises a linear feeding module with two actuators, one of the actuators of the linear feeding module is used for conveying a positive electrode sheet, and the other actuator of the linear feeding module is used for conveying a negative electrode sheet;
the conveying assembly comprises a turntable and a plurality of manipulators arranged on the turntable, wherein the manipulators are used for picking up and conveying the electrode sheet, and the turntable is used for controlling the manipulators to switch among the feeding assembly, the positioning assembly and the stacking station;
the positioning assembly is used for positioning and rectifying deviation of the electrode sheet;
the stacking station is used for stacking; and
the positioning assembly comprises a positive electrode sheet positioning assembly and a negative electrode sheet positioning assembly symmetrically arranged around the turntable, wherein the feeding assembly, the positive electrode sheet positioning assembly, the stacking station and the negative electrode sheet positioning assembly are arranged in a circular distribution centered around the conveying assembly.

2. The stacking device according to claim 1, wherein the turntable is provided with a first lifting device for controlling the lifting of the manipulators, and the first lifting device is a motor screw assembly; and
wherein the manipulator is connected with a screw in the motor screw assembly, and the manipulator is provided with a plurality of vacuum adsorption holes for adsorbing the electrode sheet.

3. The stacking device according to claim 1, wherein the positioning assembly comprises a positioning table, a first camera assembly arranged above the positioning table, and an adjusting assembly arranged below the positioning table; and
wherein the first camera assembly takes pictures of the electrode sheet on the positioning table when the manipulator places an electrode sheet on the positioning table, and a position of the positioning table is calibrated by the adjusting assembly.

4. The stacking device according to claim 1, wherein the stacking station comprises a stacking base plate, and two groups of pressing claw assembly are symmetrically arranged around the stacking base plate;
wherein the pressing claw assembly comprise a second lifting device, a first transverse moving device arranged at an output end of the second lifting device and a pressing claw arranged at an output end of the first transverse moving device; and
wherein the two groups of pressing claw assembly work alternately for pressing electrode sheet on the stacking base plate.

5. The stacking device according to claim 4, wherein two groups of second camera assembly are arranged above the stacking station, which are symmetrical with the stacking base plate as the center, and the second camera assembly cooperates with the pressing claw assembly for detecting spacing between the positive electrode sheet and the negative electrode sheet on the stacking base plate.

6. The stacking device according to claim 1, further comprising a swing roller assembly for guiding a moving direction of a separator for stacking, wherein the swing roller assembly comprises a swing roller bottom plate, a swing roller frame, a swing roller arranged on the swing roller frame and a swing roller driving device for controlling the position of the swing roller, wherein the stacking station is arranged on the swing roller bottom plate, the swing roller frame is rotatably arranged at both ends of the stacking station, and the swing roller driving device has two output ends, and the two output ends of the swing roller driving devices are each connected to a connecting rod through an eccentric wheel, wherein one end of the connecting rod, away from the eccentric wheel, is connected to the swing roller frame.

7. The stacking device according to claim 1, wherein both ends of the linear feeding module are provided with a slicing and picking device, which comprises a slicing and picking mechanism, a rotating mechanism for controlling the rotation of the slicing and picking mechanism and a third lifting mechanism for controlling the lifting of the slicing and picking mechanism, wherein the slicing and picking mechanism comprises a picking assembly and a slicing assembly, wherein the slicing assembly comprises a supporting plate and a folding assembly arranged on the supporting plate, and the picking assembly arranged on both sides of the supporting plate are movably connected with the folding assembly respectively, and wherein the slicing and picking mechanism further comprises a cam structure for limiting movement of the picking assembly.

8. The high-speed stacking device according to claim 7, wherein the picking assembly comprises a picking plate and a plurality of vacuum suction cups uniformly distributed on the picking plate;
wherein the cam structure comprises a limiting plate with a limiting groove and a moving plate with a protruding structure, the limiting plate is arranged on the supporting plate, the moving plate is fixedly arranged on the picking plate, and the protruding structure is limited in the limiting groove;
wherein the folding assembly comprises a folding driving device and a folding plate connected to an output end of the folding driving device, the folding plate is provided with a rotating shaft, and the picking plate is provided with a fixing plate which is connected to the rotating shaft through the swing arm.

9. A stacking production line comprising the high-speed stacking device according to claim 1.

10. A stacking method, wherein the stacking process uses the high-speed stacking device according to claim 1 or uses the stacking production line according to claim 9 for stacking electrode sheets, comprising the following steps:
S1, electrode sheet feeding; conveying, by the linear feeding module, a positive or negative electrode sheet to a middle part thereof, controlling, by the turntable, the manipulator to rotate to the upper part of the linear feeding module, and controlling, by the first lifting device, the manipulator to descend and pick up the electrode sheet and then ascend;
S2, electrode sheet positioning; controlling the turntable to rotate to drive the manipulator picking up the electrode sheet to rotate to the positioning assembly and placing the electrode sheet on the positioning table, taking pictures by the first camera assembly to detect the position of the electrode sheet, and adjusting and positioning the positioning table in cooperation with the adjusting assembly;
S3, electrode sheet feeding for the second time; picking up the electrode sheet after positioning adjustment by the positioning table by the manipulator;
S4, stacking; guiding, by the swing roller assembly, a separator in a Z-shaped direction, placing, by the manipulator, the electrode sheet on the stacking station, and pressing the electrode sheet on the stacking base plate in cooperation with the pressing claw assembly;
S5, stacking calibration; recording, by the cooperation of the pressing claw assembly and the second camera assembly, a variable distance between the positive electrode sheet and negative electrode sheet to judge whether production requirements are met; and
S6, unloading; unloading a battery cell after a finished stacking.
